(19) United States
(12) Patent Application Publication
(10) Pub. No.: US 2025/0201544 A1
(43) Pub. Date: Jun. 19, 2025

(54) APPARATUS FOR AN ION SPECTROMETRIC SYSTEM THAT FACILITATES THE TRANSMISSION OF IONS

(71) Applicant: Bruker Switzerland AG, Fällanden (CH)

(72) Inventors: Benjamin JONES, Billerica, MA (US); Mark RIDGEWAY, Stow, MA (US); Melvin Andrew PARK, Billerica, MA (US)

(21) Appl. No.: 18/982,175

(22) Filed: Dec. 16, 2024

Related U.S. Application Data
(60) Provisional application No. 63/610,732, filed on Dec. 15, 2023.

(51) Int. Cl. H01J 49/06

(52) U.S. Cl. CPC H01J 49/061

(57) ABSTRACT

An apparatus for an ion spectrometric system facilitates the transmission of ions and comprises a concave ion deflector, having a plurality of conducting electrodes following an inward curved surface. The apparatus also includes a pusher that deflects ions, an RF voltage supply that applies an RF voltage to the concave ion deflector and an output configured to emanate a directed gas flow comprising ions toward the inward curved surface of the concave ion deflector. The output is located outside the concave ion deflector and the concave ion deflector is configured to retain and deflect ions coming from the output while simultaneously allowing other particles coming from the output to pass through the plurality of conducting electrodes. The present invention also relates to a method for facilitating the transmission of ions in an ion spectrometric system.

### BACKGROUND OF THE INVENTION

### Field of the Invention

The present invention relates generally to ion spectrometric systems that facilitate the transmission of ions and, more specifically, to deflector arrangements used in the transport and deflection of ions from gas streams into other ion transmission components.

### Description of the Related Art

The apparatus for facilitating the transmission of ions described herein is an enhancement of the techniques referred to in the literature relating to ion spectrometry such as mass and/or ion mobility spectrometry—important tools in the analysis of a wide range of chemical compounds. Mass spectrometers, for example, can be used to determine the molecular weight of sample compounds. The analysis of samples by mass spectrometry consists of three main steps: formation of gas phase ions from sample material, mass analysis (more precisely, mass to charge ratio (m/z) analysis) of the ions, and detection of the ions. A variety of means and methods exist in the field of mass spectrometry to perform each of these three functions. The particular combination of the means and methods used in a given mass spectrometer determine the characteristics of that instrument.

To mass analyze ions, for example, one might use magnetic or electrostatic analysis, wherein ions passing through a magnetic or electrostatic field will follow a curved path. In a magnetic field, the curvature of the path will be indicative of the momentum-to-charge ratio of the ion. In an electrostatic field, the curvature of the path will be indicative of the energy-to-charge ratio of the ion. If magnetic and electrostatic analyzers are used consecutively, then both the momentum-to-charge and energy-to-charge ratios of the ions will be known, and the mass of the ion will thereby be determined. Other mass analyzers are the quadrupole (Q), the ion cyclotron resonance (ICR), the time-of-flight (TOF), and the ion trap analyzers (such as 3D, cylindrical, quadrupole and Orbitrap™ ion trap analyzers). The analyzer which accepts ions from the apparatus described herein may be any of a variety of these.

Before mass analysis can begin, gas phase ions must be formed from a sample material. Examples for ionization methods are electrospray ionization (ESI), matrix-assisted laser desorption/ionization (MALDI), electron ionization (EI), and photoionization, to name but a few.

Because the ion production (ion source), mass analysis (mass analyzer), detection of the ions as well as further means and steps that may be comprised and realized by a mass spectrometer—such as means for ion manipulating, selecting or fragmenting—can be located in different regions with different pressure regimes, ion transmission between the ion production region and the other regions can be of major importance for the functioning of the mass spectrometer. When using, for example, an ESI ion source, ions are formed and initially reside in a high pressure region (e.g., 0.1 bar) together with other constituents such as “carrier” gas and incompletely desolvated liquid droplets generated by or originating from the ESI. In order for the gas phase ions to enter the mass analyzer, the ions must therefore be separated from the other constituents prevalent in the ion production region and transported through one or more vacuum stages.

The use of multipole ion guides has been shown to be an effective means of transporting ions through a vacuum system, see for example U.S. Pat. No. 4,963,736 A. Under the generic term of “ion guide” or “ion deflector,” different electrical devices are used, such as quadrupole, hexapole or octupole rod systems, but also stacked ring electrodes (see, for instance, U.S. Pat. No. 6,891,153 B2). The function of the ion guides/ion deflectors is to confine, focus and transfer the ion beam throughout the intermediate vacuum stages via an applied DC, RF, or a combination of applied voltages.

To improve the separation of ions from other constituents or particles prevalent in the ion production region and to therefore reduce the level of contamination caused by the undesired entry of particles other than ions into downstream regions, such as the mass analysis region, U.S. Pat. No. 7,851,752 B2 suggests to place the capillary for ion injection orthogonal between the entrance of a stacked ring ion guide and an electrode plate, wherein a repulsive potential is applied to the electrode plate so that ions exiting the capillary are directed toward and into the inlet of the ion guide, whereas uncharged particles exiting the capillary are not affected by the repulsive potential and therefore passing the entrance of the ion guide without being guided into the ion guide. However, since the ions are not directly injected into the ion guide, the ions coming from the capillary may only be partly diverted into the ion guide by the applied repulsive potential, especially when the gas load coming from the capillary is increased.

U.S. Pat. No. 8,698,075 B2 discloses an in-guide orthogonal ion injection apparatus, comprising a stacked ring ion guide with an inlet capillary that inserts through an opening disposed on one side of the ion guide between two electrode lenses downstream from a first electrode lens of the ion guide that delivers ions into the ion guide orthogonal to the ion guide axis. Additionally, the in-guide orthogonal ion injection apparatus also comprises a shield comprising an electrically insulating material that covers the inlet capillary through the opening into the ion guide. The inlet design according to U.S. Pat. No. 8,698,075 B2 suffers the disadvantage that, even though the inlet capillary is covered by a shield, a non-negligible and, if at all, only limited controllable interaction of the capillary and the ions produced at the capillary (even before their injection into the ion guide) with the ring electrodes in immediate vicinity to the capillary reaching into the ion guide is to be expected. Such an interaction can in turn have a negative effect on the trajectory and movement of the ions injected into the ion guide and limit the ability to activate or otherwise condition ions before entering the ion guide. For example, the shield that covers the inlet capillary in the set-up according to U.S. Pat. No. 8,698,075 B2 could charge and produce its own uncontrolled electric field. Furthermore, in the set-up according to U.S. Pat. No. 8,698,075 B2 the distance from the capillary exit to the RF barrier in the ion guide is set by the inner diameter of the ion guide, which means that an arbitrary adjustment of the distance for the ions coming from the inlet capillary to decelerate is not possible.

The same applies for the inlet design as disclosed by Su et al. (“Multiplexing of Electrospray Ionization Sources Using Orthogonal Injection into an Electrodynamic Ion Funnel”, Anal. Chem. 2021, 93, 11576-11584), where orthogonal injection inlets implemented also directly insert in openings disposed on the opposite sides of a stacked ring ion guide.

U.S. Pat. No. 9,620,347 B2, according to its FIG. 5, does also disclose an embodiment where ions are orthogonally introduced in a stacked ring ion guide through an opening disposed on one side of the ion guide. According to U.S. Pat. No. 9,620,347 B2, the ion injection device seems not necessarily to reach into the opening of the ion guide. However, also in this case a strong and undesired early interference of the ions injected from the ion injection device has to be expected when the ions are entering the ion guide orthogonally, as the opening through which the ions enter the ion guide represents a channel of multiple electrodes, which the ions first have to pass before getting into the inside of the ion guide.

Furthermore, in particular in cases where high mass flows coming from the ion source (e.g., resulting from the use of atmospheric pressure interfaces and/or resulting from increasing capillary sizes in ESI) need to be transmitted into regions with lower pressure, a highly efficient working ion deflector is needed for transmission of ions in order to achieve a high level of separation of ions from other particles while keeping the loss of ions at the same time as small as possible. However, as an increasing mass flow coming from the ion source puts more force in the direction across the deflector (i.e., towards the direction of lower pressure), the aforementioned requirements are not easy to fulfill at high mass flows and are often not met by deflectors known from the prior art. If an ion path is not bent strongly enough, ions will be typically lost to the deflector electrodes or removed out of the system together with the other constituents coming from the ion source (e.g., via the pumping port). In contrast, if the ion path is bent too hard likewise, ions will collide with elements of the deflector on their way through it and will be lost as a result as well. Accordingly, there is also a need for an RF deflector which can handle high mass flows in an efficient manner and in this respect is suitable for transmitting a broad range of ion trajectories.

As discussed below, the apparatus according to the present invention overcomes many of the limitations of prior art apparatuses for transmission of ions. The apparatus disclosed herein provides a unique combination of attributes making it more suitable for use in the transport of ions from an ion source to a mass analyzer by overcoming or minimizing disadvantages associated with the aforementioned apparatuses for transmission of ions known from the prior art.

### SUMMARY OF THE INVENTION

According to a first aspect of the invention, the invention relates to an apparatus for an ion spectrometric system, preferably for a mass spectrometric and/or ion mobility spectrometric system, that facilitates the transmission of ions, said apparatus comprising
a concave ion deflector, the concave ion deflector comprising
   a multitude of conducting electrodes forming an inward curved surface, and
   a pusher element for deflecting ions (in downstream direction);
an RF voltage supply for applying an RF voltage to the concave ion deflector, in particular for applying an RF voltage to at least a subset of the multitude of conducting electrodes of the concave ion deflector; and
an output designed and configured to emanate a directed gas flow comprising ions; wherein
the output and the concave ion deflector are arranged to each other in such a way that the directed gas flow comprising ions is (substantially) directed toward the inward curved surface of the concave ion deflector;
the output is located outside the concave ion deflector; and
the concave ion deflector is designed and configured to retain and deflect (at least part of the) ions coming from the output while simultaneously allowing other particles (typically uncharged particles) coming from the output to pass through the inward curved surface.

According to a second aspect of the invention, the invention relates to an apparatus for an ion spectrometric system, preferably for a mass spectrometric and/or ion mobility spectrometric system, that facilitates the transmission of ions, said apparatus comprising
a concave ion deflector, the concave ion deflector comprising
   a multitude of conducting electrodes forming an inward curved surface, and
   a pusher element for deflecting ions (in downstream direction);
an RF voltage supply for applying an RF voltage to the concave ion deflector, in particular for applying an RF voltage to at least a subset of the multitude of conducting electrodes of the concave ion deflector; and
an output designed and configured to emanate a directed gas flow comprising ions; wherein
the output is arranged such that an axis on which the directed gas flow comprising ions moves along intersects the inward curved surface of the concave ion deflector; the output is located outside the concave ion deflector; and
the concave ion deflector is designed and configured to retain and deflect (at least part of the) ions coming from the output while simultaneously allowing other particles (typically uncharged particles) coming from the output to pass through the inward curved surface.

One advantage of the apparatus according to the invention is that the arrangement of output and concave ion deflector to each other in combination with the special design of the concave ion deflector according to the invention enables ideal separation of the ions to be transmitted from any other particles coming from the output. The fact that the directed gas flow comprising ions emanated from the output is (substantially) directed toward the inward curved surface of the concave ion deflector (i.e., toward the inside of the concave ion deflector) simultaneously ensures in an advantageous manner the probability that a large part of the ions coming from the output experience the forces at the ion deflector provided for retaining and deflecting the ions. In particular in embodiments where the directed gas flow comprising ions emanated from the output is completely directed toward the inward curved surface of the concave ion deflector, generally none or at least only a negligible proportion of the ions coming from the output will leave the corresponding region without an interaction with the electric fields prevailing at the ion deflector during operation. This interplay of effects results in a maximization of the yield of ions that can be transferred from the output to other regions of the mass spectrometric system (such as the mass analyzer) while at the same time separation of other constituents than ions also coming from the output (such as analyte molecules that have not undergone ionization in the ion source, liquid droplets or excess gas particles) can be realized in an highly efficient manner.

In this context, the concave shape of the ion deflector allows the directed gas flow comprising ions emanated from the output in the direction of the inward curved surface of the ion deflector to have a relatively large entrance area available for entry into the concave ion deflector, which allows the output to be located outside the concave ion deflector, as defined according to the invention, without having any significant loss of directed gas flow or ions coming from the output and moving toward the inward curved surface.

The relatively large entrance area for the directed gas flow comprising ions made possible by the concave shape of the ion deflector, in combination with the location of the output outside the ion deflector, also has the effect that undesirable interactions in particular of the ions on their way from the output into the ion deflector are kept to a minimum and, in the best case, are completely avoided. By avoiding or reducing such undesirable interactions of the ions in advance of reaching the inside of the ion deflector, the deflection of the ions to be achieved by the electric fields deliberately applied in the ion deflector is more predictable and thus more readily achievable.

In this way, the apparatus according to the invention differs significantly from apparatuses for the transmission of ions known from the prior art, where the ions are generated or injected in the immediate vicinity of voltage-carrying components (e.g., in the vicinity of the electrodes of the ion guide) or where the ions have to pass voltage-carrying components (such as electrodes or segments of electrodes) at a relatively short distance therefrom in order to reach the inside of the ion deflector or ion guide.

The expression “that the directed gas flow comprising ions is (substantially) directed toward the inward curved surface of the concave ion deflector” means in the context of the invention that the flight path of the directed gas flow comprising ions emanated from the output is such that the directed gas flow comprising ions is substantially directly moving toward the inward curved surface of the concave ion deflector and is able to reach the inward curved surface, unless the particles of the directed gas flow comprising ions are not previously retained and deflected by electric fields prevailing at the concave ion deflector during operation. Accordingly, the expression “that the directed gas flow comprising ions is (substantially) directed toward the inward curved surface of the concave ion deflector” implies that there are generally no components on the initial flight path given by the output for the directed gas flow comprising ions coming from it, with which the directed gas flow comprising ions emanated from the output could collide and accordingly could be prevented from reaching the inward curved surface of the concave ion deflector.

The expression “that the directed gas flow comprising ions is (substantially) directed toward the inward curved surface of the concave ion deflector” does not in principle exclude the existence of other parts or elements between the output and the concave ion deflector. For example, and according to preferred embodiments of the invention, components are allowed between the output and the concave ion deflector as long as they are not located on the initial predetermined flight path of the directed gas flow comprising ions emanated from the output toward the inward curved surface of the concave ion deflector. Examples of such components are components which, due to their arrangement or shape, do not block the initial flight path of the directed gas flow comprising ions emanated from the output to the inward curved surface of the concave ion deflector, such as a shield surrounding the output in such a way that the initial flight path of the directed gas flow comprising ions emanated from the output is not blocked.

However, according to other preferred embodiments of the invention, there are no other parts or elements of any kind between the output and the concave ion deflector.

The term “concave” is to be understood broadly in the context of the present invention and expresses that the ion deflector comprises a hollow space with a corresponding inner (inward curved) surface. The inward curved surface may have various shapes and may, for example, in a two-dimensional projection, be shaped like a “C”, a “U”, or a horseshoe. The inward curved surface may, in a two-dimensional projection, also have the shape of an open rectangle (cuboid), an open square (cube), or a “>”-shape. According to the invention, it is also possible that the shape of the inward curved surface of the concave ion deflector varies along the ion deflector. However, in various preferred embodiments, the shape of the inward curved surface remains the same along the concave ion deflector (at least within the limits of slight variations due to construction).

All shapes of the concave ion deflector have in common that they have an opening through which the directed gas flow comprising ions emanated from the output and moving toward the inward curved surface of the concave ion deflector can easily enter the concave ion deflector. This opening can, but does not necessarily have to, extend over the entire length of the concave ion deflector.

According to various preferred embodiments of the invention, the inward curved surface of the concave ion deflector may comprise a protuberance, preferably located directly opposite the output. Such a protuberance can serve as a pseudo jet disruptor for, e.g., breaking off the directed gas flow coming from the output to either side of the protuberance rather than directly guiding it to the conducting electrodes of the concave ion deflector forming the inward curved surface. The protuberance may extend along the entire length of the inward curved surface or may be limited to a specific place or area of the inward curved surface.

According to the invention, “entering” the concave ion deflector or being “in” or “inside” the concave ion deflector means that the directed gas flow comprising ions, or the corresponding ions thereof, enter or are located within an area or hollow space which is enclosed or surrounded by the inward curved surface of the concave ion deflector or by any other components of the concave ion deflector (such as by concave electrodes of the concave ion deflector or by ring electrodes forming an ion tunnel or ion funnel which may be part of the concave ion deflector and may serve as entrance into the concave ion deflector for the directed gas flow comprising ions emanated from the output).

In turn, according to the invention, “outside” the concave ion deflector means outside the area or hollow space which is enclosed or surrounded by the inward curved surface of the concave ion deflector or by any other components of the concave ion deflector. With respect to the output which, according to the invention, is located outside the concave ion deflector this means that the output is located outside the area or hollow space which is enclosed or surrounded by the inward curved surface of the concave ion deflector or by any other components of the concave ion deflector. Therefore, according to the invention, the output also has for example no overlap with electrodes of the concave ion deflector and in this respect differs from arrangements known from the prior art, such as those disclosed in U.S. Pat. No. 8,698,075 B2.

As mentioned above and as defined in the claims, according to the invention the output and the concave ion deflector are arranged to each other in such a way that the directed gas flow comprising ions is (substantially) directed toward the inward curved surface of the concave ion deflector. Accordingly, the apparatus according to the invention differs from such apparatuses for the transmission of ions known from the prior art in which an output is arranged in such a way that ions coming from the output move toward an outwardly curved surface. The apparatus according to the invention also differs from those apparatuses for the transmission of ions known from the prior art in which an output is arranged in such a way that ions coming from the output enter the ion deflector or ion guide axially (i.e., parallel) without directly moving toward an inner surface (such as an inward curved surface) of the ion deflector or ion guide.

The fact that the output and the concave ion deflector are arranged to each other in such a way that the directed gas flow comprising ions is (substantially) directed toward the inward curved surface of the concave ion deflector does not usually mean that the ions coming from the output actually reach the inward curved surface of the concave ion deflector during operation or come into contact with it, since the ions are usually retained beforehand by the electric fields prevailing at the concave ion deflector during operation and are deflected onto an ion guiding path leading (in downstream direction) along the concave ion deflector. The situation is different for uncharged particles and constituents also coming from the output together with the ions, which, unlike the ions, experience no or hardly any retention and/or deflection by the electric fields prevailing at the concave ion deflector during operation and instead continue to move toward the inward curved surface (mostly) unaffected by prevailing electrical fields and potentials. For this reason and according to the invention, the concave ion deflector is designed in such a way that particles and constituents reaching the inward curved surface can generally pass through it and thus can leave the concave ion deflector again.

The concave ion deflector during operation thus acts, so to speak, as an ion sieve through which ions are retained but other (in particular uncharged) constituents are allowed to pass. During operation, the concave ion deflector thus causes at least partial, preferably substantial, more preferably complete, separation of the ions contained in the directed gas flow from any other particles or constituents therein, wherein the arrangement of output and concave ion deflector to each other nevertheless ensures that the directed gas flow emanated from the output, and in particular the ions contained therein, enter the concave ion deflector to the greatest extent possible.

The invention also covers embodiments in which not all ions are retained by the electric field or electric fields prevailing at the concave ion deflector during operation. Such an incomplete retention of ions may occur, for example, in the case of a large quantity of ions coming from the output or when ions coming from the output possess a particularly high mass and/or velocity such that the retention forces at the concave ion deflector are not strong enough to at least completely retain all ions coming from the output. However, in general the apparatus according to the invention is capable of ensuring efficient separation of ions from other constituents of the directed gas flow even at high mass flows (such as at mass flows of 8 L/min) and of deflecting the ions on an ion guiding path along the concave ion deflector towards, e.g., a mass analyzer with no or at least minimal loss of ions and by covering a broad range of ion trajectories.

The RF voltage supply for applying an RF voltage to the concave ion deflector is configured to apply the RF voltage at least to particular areas of the concave ion deflector, such as a subset of the multitude of conducting electrodes of the concave ion deflector (e.g., to one or more electrodes). The RF voltage supply may be configured to apply an RF voltage with a frequency in the range between 100 kHz and 10 MHz, preferably in the range between 500 kHz and 5 MHz, more preferably in the range between 500 kHz and 1500 kHz. Furthermore, the RF voltage supply may be configured to apply an RF voltage with an amplitude in the range between 50 volts and 1500 volts, preferably between 50 volts and 500 volts, more preferably between 100 volts and 500 volts. The RF voltage applied to the concave ion deflector primarily serves for creating an RF pseudopotential barrier in order to confine the ions which enter the concave ion deflector and/or in order to repel ions approaching the inward curved surface, thereby preventing ions from passing through the inward curved surface or colliding with parts of the concave ion deflector. In some embodiments, the RF voltage applied to the concave ion deflector can also serve for deflecting ions which enter the concave ion deflector in order to lead the ions on an ion guiding path (in downstream direction) along the concave ion deflector and to enable the transmission of the ions into any devices that may be located downstream after the concave ion deflector, such as an ion optic.

According to the invention, the concave ion deflector comprises a pusher element for deflecting ions, in particular for deflecting ions (in downstream direction) along the concave ion deflector; i.e., along an ion guiding path inside the concave ion deflector or along the inward curved surface of the concave ion deflector, respectively, toward one end of the concave ion deflector. In other words, and in the context of the present invention, the “pusher element for deflecting ions” can also be understood as a device through which ions entering or approaching the concave ion deflector experience a driving force to move them along the concave ion deflector. The expression “along the inward curved surface” is to be understood merely as a directional description and does not mean that the guided ions necessarily come into contact with the inward curved surface or inner parts of the concave ion deflector. In fact, the ions which are deflected toward a direction along the concave ion deflector preferably do not come into contact with the inward curved surface of the concave ion deflector, or with the concave ion deflector at all, due to the pseudopotential barrier created by the RF voltage applied to the concave ion deflector during operation.

Accordingly, the pusher element for deflecting ions serves to guide the ions coming from the output onto an ion guiding path (in downstream direction) along the concave ion deflector in order to facilitate the transmission of the ions coming from the output and to transfer them from one region of an ion spectrometric system to another region. In addition, the pusher element and the (typically sideways) movement forced by the pusher element on the ions, previously moving from the output toward the inward curved surface of the concave ion deflector, assists in the separation of the ions from other particles and constituents of the directed gas flow emanated from the output, in that the force exerted by the pusher element on the ions during operation alters their trajectory relative to other (uncharged) particles and constituents and, thereby, promotes a spatial separation of the ions from such other particles and constituents.

Preferably, the movement of the ions entering or approaching the concave ion deflector (in downstream direction) along the concave ion deflector is realized by applying a DC voltage to at least a subarea of the concave ion deflector in order to establish a DC voltage gradient along the concave ion deflector and to therefore force the ions along an ion guiding path leading to one end of the concave ion deflector (directed downstream). The applied DC field may be linear, logarithmic, parabolic, or another function. Preferably, the established DC voltage gradient may be in the range of 5 to 200 volts per centimeter length of the concave ion deflector, preferably in the range of 30 to 150 volts per centimeter length of the concave ion deflector.

Correspondingly, according to various preferred embodiments of the invention, the apparatus according to the invention may further comprise a DC voltage supply for applying a DC voltage to the concave ion deflector, in particular for applying a DC voltage to at least a subset of the multitude of conducting electrodes and/or to the pusher element of the concave ion deflector. However, according to the invention, the deflection and movement of the ions along the concave ion deflector can also be realized by applying an RF voltage (with preselected frequency and amplitude) to at least a subset of the multitude of conducting electrodes that directs ions entering or approaching the concave ion deflector along an ion guiding path.

Preferably, the pusher element comprises, or is, a repeller electrode.

According to a preferred embodiment of the invention, the repeller electrode can also act as terminating electrode at one end of the concave ion deflector. In that case, such a terminating electrode is, e.g., disposed at one of the two ends of the multitude of conducting electrodes forming the inward curved surface of the concave ion deflector in such a way that the DC voltage applied to the terminating electrode can push the ions entering the concave ion deflector in the downstream direction of the concave ion deflector.

In the context of the invention, the inward curved surface of the concave ion deflector is to be understood as a notional surface which is formed by a multitude of conducting electrodes and which extends over the inner walls of these electrodes (including any holes in these electrodes and any gaps between adjacent electrodes) and which in general is at least partially permeable for at least certain particles (in particular uncharged particles) coming from the output. The ability of the concave ion deflector to allow (in particular uncharged) particles coming from the output to pass through the inward curved surface can be realized in several ways. For example, there may be holes or channels in or between the multitude of conducting electrodes forming the inward curved surface through which those particles that are not retained and deflected onto a path (in downstream direction) along the concave ion deflector by the forces prevailing in the concave ion deflector, can leave the concave ion deflector again.

It has to be mentioned that the concave ion deflector of an apparatus according to the invention may not allow all particles coming from the output and reaching the inward curved surface of the concave ion deflector (because being not or not properly deflected or retained by the forces prevailing in the concave ion deflector) to pass through it, since some of such particles, e.g., may not hit one of the holes, gaps or channels in the concave ion deflector or, after entering one of the channels of the concave ion deflector, may collide with the inner wall of that channel. Therefore, the term “the concave ion deflector is designed and configured to retain and deflect ions coming from the output while simultaneously allowing other particles coming from the output to pass through the inward curved surface” in the context of the present invention is to be understood as allowing at least some particles coming from the output (and which are not deflected onto a path in downstream direction along the concave ion deflector by the forces prevailing in the concave ion deflector) to pass through the concave ion deflector. However, according to various preferred embodiments of the invention, the concave ion deflector is designed and configured to allow at least a substantial part of the particles, which are coming from the output and are not deflected onto a path (in downstream direction) along the concave ion deflector, to pass through the inward curved surface.

Furthermore, according to the invention, also ions coming from the output that may not be deflected properly onto a path (in downstream direction) along the concave ion deflector may pass through the concave ion deflector together with any uncharged particles.

In various preferred embodiments of the invention, one or more, preferably all, electrodes of the multitude of conducting electrodes of the concave ion deflector (forming the inward curved surface) are concave. Preferably, one or more, preferably all, of the multitude of conducting electrodes of the concave ion deflector (forming the inward curved surface) are C-shaped, U-shaped and/or horseshoe shaped electrodes. Preferably, the multitude of conducting electrodes of the concave ion deflector each have a thickness in the range of 0.2 mm to 1 mm, more preferably a thickness in the range of 0.45 mm to 0.65 mm.

In the context of the present invention, a “multitude of conducting electrodes” is understood to mean two or more electrodes. The term “multitude of conducting electrodes” is accordingly to be understood broadly in the context of the invention. Preferably, the concave ion deflector comprises a number of 5 to 40, more preferably 18 to 20, electrodes.

Furthermore, in various preferred embodiments of the invention, the multitude of conducting electrodes of the concave ion deflector are (at least partly) aligned along a common axis such that said electrodes form an ion guiding path. In such preferred embodiments, the inward curved surface is usually formed by the alignment of the multitude of (concave) conducting electrodes of the concave ion deflector and typically extends over all aligned electrodes.

The multitude of conducting electrodes of the concave ion deflector may be aligned along a common axis by, e.g., a holder through which the electrodes are held aligned and/or by joining the electrodes together using spacers between the electrodes. The holder and/or the spacers preferably comprise, or consist of, an electrically insulating material. Accordingly, the holder and/or the spacers preferably have an electrically insulating effect. It goes without saying that, if spacers are located between adjacent conducting electrodes, the spacers will be configured and located such that they do not substantially block other particles and constituents (typically uncharged particles), as opposed to ions and charged molecules, from passing through the inward curved surface formed by the conducting electrodes.

Preferably, adjacent aligned electrodes of the multitude of conducting electrodes of the concave ion deflector are separated from each other by separation distances (also designated as gaps), more preferably by uniform separation distances. Preferably, the separation distances between adjacent aligned electrodes of the multitude of conducting electrodes of the concave ion deflector are in the range of 0.5 mm to 1.5 mm, more preferably in the range of 0.6 mm to 0.8 mm (measured from the end of one electrode to the beginning of the adjacent aligned electrode). Reduced open separation distances between adjacent aligned electrodes result in higher maximum repelling fields prevailing at the inward curved surface during operation (i.e., during applying an RF voltage to the concave ion deflector) and therefore increase the RF pseudopotential barrier for the ions coming from the output and moving toward the inward curved surface of the concave ion deflector. The distances between adjacent aligned electrodes measured from center to center of the adjacent aligned electrodes may be in the range of 1.0 mm to 1.5 mm, preferably in the range of 1.2 mm to 1.3 mm. The separation distances between adjacent aligned electrodes of the multitude of conducting electrodes of the concave ion deflector may be completely or partially filled with a material having an electrically insulating effect.

According to further preferred embodiments of the invention, adjacent aligned electrodes of the multitude of conducting electrodes of the concave ion deflector are separated from each other by separation distances and one, several or all of said separation distances form flow paths through which particles coming from the output (which are not deflected onto a path in downstream direction along the concave ion deflector by the forces prevailing in the concave ion deflector) can exit the concave ion deflector.

According to the invention, the output generally can be of any kind as long as it is capable of emitting a directed gas flow comprising ions. However, in various preferred embodiments of the invention, the output may be (the outlet of) a capillary or an orifice, preferably (the outlet of) a capillary for electrospray ionization (ESI). In preferred embodiments, the diameter of a capillary or orifice is in the range of 0.1 to 1.5 mm, preferably in the range of 0.1 to 1.3 mm.

Another conceivable type of output is a device for matrix-assisted laser desorption/ionization (MALDI), wherein the device is designed and arranged in such a way that the MALDI sample, after desorption and ionization, (at least partly) moves or is directed toward the inward curved surface of the concave ion deflector. Furthermore, the output may be configured to eject simultaneously or successively ions produced by more than one ionization technique and/or coming from more than one ion source toward the (inward curved surface of the) concave ion deflector. For example, the output may comprise one device for ejecting ions produced via MALDI and one device for the ejecting ions produced via ESI. The invention also covers embodiments in which, e.g., a matrix-assisted laser desorption/ionization is performed from behind the concave ion deflector and where after desorption and ionization the ions first travel to the front of the concave ion deflector, where they are pushed by an output, for example by a gas flow from a capillary, toward the inward curved surface of the concave ion deflector.

The concave ion deflector for an apparatus according to the invention or the electrodes of a corresponding concave ion deflector can in principle be made of any material suitable for this purpose. Typically, the ion deflector or the electrodes of a corresponding concave ion deflector are made of one or more materials selected from the group comprising or consisting of beryllium copper, phosphor bronze, stainless steel, Inconel™, Elgiloy™ and Hastelloy™. Materials with superior corrosion resistance such as stainless steel, Inconel™, Elgiloy™ and Hastelloy™ are preferred.

As already mentioned above, all shapes of the concave ion deflector have in common that they have an opening through which the directed gas flow comprising ions emanated from the output and moving toward the inward curved surface of the concave ion deflector can easily enter the concave ion deflector. The size of the opening through which the directed gas flow comprising ions emanated from the output and moving towards the inward curved surface can enter the concave ion deflector can vary according to the invention and can be determined, among other things, by the extent to which the sides of the inward curved surface or the components of the concave ion deflector at the opening enclose an area or hollow space inside the concave ion deflector. In various preferred embodiments of the invention, the inward curved surface of the concave ion deflector or the electrodes of the concave ion deflector at the opening of the concave ion deflector may enclose an area or hollow space inside the concave ion deflector by 45 to 315°, preferably by 120 to 240°, more preferably by 180°. For example, in cases where the inward curved surface of the concave ion deflector has, in a two-dimensional projection, the shape of a semicircle or the shape of a “U”, the inward curved surface (and the electrodes of the concave ion deflector forming the shape of a semicircle or the shape of a “U”) encloses an area or hollow space inside the concave ion deflector by 180°. If the inward curved surface encloses the area less strongly, the value will be smaller, and vice versa.

The size of the opening through which the directed gas flow comprising ions emanated from the output and moving toward the inward curved surface of the concave ion deflector can enter the concave ion deflector can also be determined by the distance between the two opposite sides of the inward curved surface of the concave ion deflector, which (compared to a plane surface) are approaching each other due to the curvature of the inward curved surface. In various preferred embodiments of the invention, the shortest distance between the two opposite sides of the inward curved surface of the concave ion deflector, which are approaching each other due to the curvature of the inward curved surface, may be in the range of 10 to 50 mm, preferably in the range of 15 to 40 mm, more preferably in the range of 20 to 30 mm, in particular 25 mm. Additionally or alternatively, the opening through which the directed gas flow comprising ions emanated from the output and moving toward the inward curved surface of the concave ion deflector can enter the concave ion deflector preferably has at least an extent of 10 to 50 mm, preferably of 15 to 35 mm, more preferably of 20 to 30 mm, in particular of 25 mm.

The preferred dimensions for the size of the opening through which the directed gas flow comprising ions emanated from the output can enter the concave ion deflector, as indicated above and as defined in the claims, simultaneously co-define, to some extent, the type and degree of curvature of the concave ion deflector. Some curvature of the concave ion deflector is required to assist in deflecting and steering the ions coming from the output. The preferred dimensions for the size of the opening mentioned above represent an ideal balance between a still sufficiently large opening for an easy and largely undisturbed entry of the directed gas flow comprising ions emanated from the output into the concave ion deflector and, at the same time, the presence of a sufficient concave curvature for the reception, confinement and desired deflection of the ions contained in the directed gas flow onto and along an ion guiding path (in downstream direction) by the electric fields prevailing in the concave ion deflector.

In various preferred embodiments of the invention, the length of the concave ion deflector or the length of the ion guiding path (with or without any ion tunnels or ion funnels that may be located upstream and/or downstream of the concave ion deflector) is in the range of 10 to 100 mm, preferably in the range of 10 to 50 mm, more preferably in the range of 15 to 25 mm. Such a length has been found to be sufficient and advantageous for efficient deflection, reorientation and confinement of ions along with simultaneous separation from other (uncharged) particles and constituents also coming from the output.

The angle at which the directed gas flow comprising ions emanated from the output moves toward the inward curved surface of the concave ion deflector or at which it enters the concave ion deflector is in principle freely selectable. Preferred, however, according to the invention are such arrangements of the output and the concave ion deflector to each other, which lead to a substantially perpendicular direction of movement of the directed gas flow comprising ions emanated from the output toward the inward curved surface or toward the opening of the concave ion deflector. Such a direction of motion has an advantageous effect on the separation of ions from other particles also coming from the output (the more perpendicular the direction of incidence of the directed gas flow comprising ions emanated from the output is to the direction of deflection forced on the ions in the concave ion deflector, the more these two directions differ from each other and the more efficient will be the separation of ions from other particles in the concave ion deflector). In addition, a largely perpendicular direction of motion of the directed gas flow comprising ions emanated from the output toward the inward curved surface or toward the opening of the concave ion deflector favors the re-emission of particles other than ions out of the concave ion deflector.

However, an angle of incidence that is not completely perpendicular is also conceivable and can be advantageous in that an oblique angle of incidence of the ions (of, for example, 45° with respect to the common axis along which the multitude of conducting electrodes of the concave ion deflector are aligned) requires lower forces to deflect the ions coming from the output onto an ion guiding path (in downstream direction) along the concave ion deflector, and allows to at least partially utilize the initial kinetic energy of the ions coming from the output for their path along the concave ion deflector (at least if the direction of movement of the ions coming from the output is such that they are already partially moving towards the exit downstream of the concave ion deflector).

Therefore, in various preferred embodiments of the invention the output and the concave ion deflector may be arranged to each other in such a way that the directed gas flow comprising ions emanated from the output moves toward the inward curved surface of the concave ion deflector at an angle of 35 to 145°, preferably at an angle of 45 to 90°, more preferably moves orthogonally toward the inward curved surface of the concave ion deflector. Furthermore, in various preferred embodiments of the invention the output and the concave ion deflector may be arranged to each other in such a way that the directed gas flow comprising ions emanated from the output moves toward and/or enters the concave ion deflector at an angle of 35 to 145° with respect to the common axis along which the multitude of conducting electrodes of the concave ion deflector are (at least partly) aligned, preferably at an angle of 45 to 90° with respect to the common axis along which the multitude of conducting electrodes of the concave ion deflector are (at least partly) aligned, more preferably moves toward and/or enters the concave ion deflector orthogonal with respect to the common axis along which the multitude of conducting electrodes of the concave ion deflector are (at least partly) aligned. Additionally or alternatively to the aforementioned preferred embodiments, in various preferred embodiments of the invention the output and the concave ion deflector may be arranged to each other in such a way that the directed gas flow comprising ions emanated from the output moves toward and/or enters the concave ion deflector at an angle of 35 to 145° (preferably at an angle of 45 to 90°, more preferably orthogonal) with respect to the orientation of the force, in particular with respect to the orientation of the electric (DC) field, prevailing at or applied to the concave ion deflector in order to move or deflect the ions entering the concave ion deflector (in downstream direction) along the concave ion deflector.

In various preferred embodiments of the invention, the output and the concave ion deflector may be arranged to each other in such a way that the directed gas flow comprising ions emanated from the output moves toward one end of the inward curved surface of the concave ion deflector. Additionally or alternatively, the output and the concave ion deflector may be arranged to each other in such a way that the directed gas flow comprising ions emanated from the output enters the concave ion deflector at one very end of the concave ion deflector. The realization of such an entry point of the directed gas flow comprising ions emanated from the output advantageously ensures the fullest possible utilization of the length of the concave ion deflector for the deflection and manipulation of the ions entering the concave ion deflector on their way through it to the other end of the concave ion deflector.

In further preferred embodiments of the invention, the output and the concave ion deflector may be arranged to each other in such a way that the directed gas flow comprising ions emanated from the output moves toward a location of the inward curved surface of the concave ion deflector near the pusher element, preferably near a repeller electrode. Such proximity of the ions entering the concave ion deflector with the directed gas flow to the pusher element ensures an intense effect of the force exerted by the pusher element on the ions during operation, in order to achieve efficient deflection and motion of the ions through the concave ion deflector.

In various preferred embodiments, the apparatus according to the invention may further comprise a shield, wherein the shield at least partially surrounds the output (of course in such a way that the initial flight path of the directed gas flow comprising ions emanated from the output is not blocked). As already mentioned above, the shape of the ion deflector as a concave, not completely enclosed, ion deflector and the fact that the output is located outside the concave ion deflector have the effect (among other things) that undesirable interactions of the ions coming from the output are kept low and are reduced to a minimum before they approach or enter the ion deflector. The shield substantially serves to further reduce any undesirable interactions of the ions that nevertheless may occur on their way from the output to the concave ion deflector. The shield may comprise or consist of any electrically conducting or electrically insulating material capable of reducing any undesirable interactions of the ions that may otherwise occur on their way from the output to the concave ion deflector.

The shield may extend into the concave ion deflector, i.e., into the area or hollow space enclosed or surrounded by the inward curved surface of the concave ion deflector. However, according to a preferred embodiment of the invention, the shield is located directly in front of the concave ion deflector, i.e., directly in front of the area or hollow space enclosed or surrounded by the inward curved surface of the concave ion deflector, and therefore preferably does not extend into the concave ion deflector.

Preferably, the shield has the shape of a tube, and the output extends into the tube. Forming the shield as a tube has further the advantage that the output extending at least partially into the tube can be shielded from any interfering influences at a maximum possible angle of 360° and at the same time can be kept free.

According to the invention, one, two, more than two or all electrodes of the multitude of conducting electrodes of the concave ion deflector can be supplied with an RF voltage. In various preferred embodiments of the present invention, each electrode of the multitude of conducting electrodes of the concave ion deflector may be connected to an RF potential.

As already mentioned, the applied RF voltage may not only serve to prevent the ions, coming from the output and moving toward the inward curved surface of the concave ion deflector, from reaching the inward curved surface and thus from colliding with the inner walls of the concave ion deflector or from exiting the concave ion deflector while passing through the inward curved surface of the concave ion deflector. The RF voltage in some embodiments may additionally also serve to guide the ions along a path (i.e., on an ion guiding path) downstream the concave ion deflector.

In various preferred embodiments of the present invention, the RF voltage applied to the concave ion deflector may comprise two or more phases, preferably two phases (0°, 180°) that are applied alternately to adjacent electrodes of the multitude of conducting electrodes of the concave ion deflector. Furthermore, the RF potential on any electrode of the multitude of conducting electrodes of the concave ion deflector connected to an RF potential may be 180 degrees out of phase with the RF potential on an adjacent electrode. Application of the RF potentials in this way reduces the creation of pseudopotential wells which thereby prevents or at least minimizes the trapping of ions.

The apparatus according to the invention may also further comprise at least one pumping port, wherein the concave ion deflector is preferably located between the output and the at least one pumping port. Such a preferred arrangement of concave ion deflector, output and pumping port has the advantage that the particles of the directed gas flow emanated from the output which pass through the inward curved surface of the concave ion deflector can be immediately removed in an efficient manner.

According to the invention, it is not excluded that further devices contributing to the transmission of ions may be connected with or being part of the concave ion deflector. In various preferred embodiments of the invention, the concave ion deflector may comprise (e.g., is operatively coupled to) at least one ion tunnel or ion funnel. In the context of the present invention, an ion funnel differs from an ion tunnel mainly in that the inner diameter gradually decreases or increases along its longitudinal extension or the direction of travel of ions. An ion tunnel or ion funnel can be located upstream as well as downstream of the concave ion deflector.

In various preferred embodiments of the invention, the concave ion deflector comprises at least one ion tunnel or ion funnel located downstream of the concave ion deflector, i.e., located downstream of that region in which the deflection of ions onto an ion guiding path along the concave ion deflector and the separation of other (in particular uncharged) particles takes place.

An ion tunnel or ion funnel located downstream of the concave ion deflector is preferably formed by a plurality of ring electrodes. The downstream located ion tunnel or ion funnel typically follows directly on the multitude of conducting electrodes of the concave ion deflector. In such preferred embodiments, the ion tunnel or ion funnel forms a prolongation of the ion guiding path and serves to further guide and confine the ions. When located downstream of the concave ion deflector, such ion funnels are preferred in which the inner diameter decreases in direction of travel.

As already mentioned above, an ion tunnel or ion funnel additionally or alternatively may also be located upstream of the concave ion deflector. In various preferred embodiments of the present invention, the directed gas flow comprising ions emanated from the output enters the concave ion deflector via an ion tunnel or ion funnel, wherein the ion tunnel or ion funnel is designed and configured to focus (at least part of the) ions coming from the output while the ions are moving toward the inward curved surface of the concave ion deflector. In particular, the ion tunnel or ion funnel through which the directed gas flow comprising ions emanated from the output enters the concave ion deflector may be capable of focusing the ions coming from the output (which may reach and enter the corresponding ion tunnel or ion funnel as kind of ion cloud in which the ions are scattered over a relatively wide area) into an ion beam before separation of any uncharged particles via deflection of this ion beam in downstream direction along an ion guiding path takes place. By focusing the ions into an ion beam prior to deflection, the mass bandwidth and sensitivity of the ion spectrometric system can be improved.

The ion tunnel or ion funnel through which the directed gas flow comprising ions emanated from the output may preferably enter the concave ion deflector can be formed by extending at least a subset of the multitude of conducting (concave) electrodes of the concave ion deflector while preferably also vary the cutout dimension of the corresponding extensions, such that an ion funnel or ion tunnel results. For example, some or all of the (concave) electrodes of the multitude of conducting electrodes of the concave ion deflector may be extended and varied in cutout dimension as a function of electrode number such that an ion tunnel or ion funnel results. Alternatively, the ion tunnel or ion funnel through which the directed gas flow comprising ions emanated from the output enter the concave ion deflector may be formed out of separate electrodes, such as a plurality of ring electrodes with or without subsequently increasing or decreasing inner diameter in the direction of travel (i.e., in downstream direction).

According to further preferred embodiments of the invention, the ion tunnel or ion funnel through which the directed gas flow comprising ions emanated from the output may enter the concave ion deflector preferably comprises a constriction along its direction of travel (i.e., in downstream direction), into which the ions coming from the output are guided and focused during their way towards the inward curved surface. The guidance of the ions into the constriction of the ion tunnel or ion funnel may be realized by a force, preferably an electrical (DC) field, pushing the ions into the constriction while an RF voltage applied to the electrodes of the ion tunnel or ion funnel and the correspondingly created RF pseudopotential barrier prevents the ions pushed in the constriction from colliding with inner parts of the ion tunnel or ion funnel or from exiting the ion tunnel or ion funnel via any holes or gaps between the electrodes of the same. The force for pushing the ions into the constriction of the ion tunnel or ion funnel may be provided by the same pusher element for deflecting ions through which ions entering or approaching the concave ion deflector already experience a driving force which moves them (in downstream direction) along the concave ion deflector. In embodiments where the pusher element is a repeller electrode, the corresponding repeller electrode can, e.g., be extended over the length of the ion tunnel or ion funnel in order to be able of fulfilling the additional task of pushing ions into the constriction of the ion tunnel or ion funnel. In such cases, the repeller electrode typically also represents the termination to one side of the ion tunnel or ion funnel.

The above-mentioned constriction for the ion tunnel or ion funnel can be designed and realized in various ways. In preferred embodiments of the invention, the ion tunnel or ion funnel through which the directed gas flow comprising ions emanated from the output may enter the concave ion deflector may be formed in such a way that the inner area of the ion tunnel or ion funnel in cross-section (i.e., perpendicular to the direction of travel) has a teardrop shape. Such a teardrop shape has been proven to be particularly efficient and practical for focusing the ions in the ion tunnel or ion funnel.

In particular in embodiments where the ion tunnel or ion funnel through which the directed gas flow comprising ions emanated from the output may enter the concave ion deflector is formed by an extension of at least a subset of the multitude of conducting (concave) electrodes of the concave ion deflector varying in cutout dimension, the specific shape of the inner area of the ion tunnel or ion funnel in cross-section (i.e., perpendicular to the direction of travel) is determined by the type and extent of the selected different cut-out dimensions for the individual electrodes. The variation in cutout dimensions for the individual electrodes (in order to, e.g., achieve a circle-like or teardrop shape for the inner area of the ion tunnel or ion funnel in cross-section) typically leads to the formation of steps or edges occurring at the transition of electrode extensions with different cutout dimensions (and visible in cross-section of the ion tunnel or ion funnel). As such steps or edges may increase the risk for undesirable trapping of ions, in preferred embodiments of the invention the shape in cross-section (i.e., perpendicular to the direction of travel) of the inner area of the ion tunnel or ion funnel through which the directed gas flow comprising ions emanated from the output may enter the concave ion deflector may (substantially) not show steps or edges and/or is comprised of rounded edges. Such measures reduce the risk of undesirable trapping of ions.

In embodiments where the directed gas flow comprising ions emanated from the output may enter the concave ion deflector via an ion funnel, the ion funnel may preferably be designed in such a way that the inner diameter of the ion funnel gradually increases along its direction of travel (i.e., is diverging in downstream direction). In other words, in preferred embodiments of the invention the directed gas flow comprising ions emanated from the output enters the concave ion deflector via an ion funnel with gradually increasing inner diameter along its direction of travel. A gradually increase (as well as a gradually decrease) of the inner diameter of the ion funnel along its direction of travel can, e.g., be achieved by gradually varying the cutout of the extended parts of the electrodes forming the ion funnel in direction of travel. A diverging diameter along the direction of travel provides additional advantage in that the RF potential applied to a corresponding ion funnel serves to propel ions even more strongly toward the inward curved surface of the concave ion deflector (and therefore toward the region where deflection of ions and separation of other particles coming from the output takes place) by means of the diverging geometry. In other preferred embodiments of the invention, the directed gas flow comprising ions emanated from the output may enter the concave ion deflector via an ion funnel with gradually decreasing inner diameter along its direction of travel.

According to a further aspect, the invention also relates to a method for facilitating the transmission of ions in an ion spectrometric system, preferably in a mass spectrometric and/or ion mobility spectrometric system, the method comprising the steps of:
a) providing an apparatus, preferably providing an apparatus or a preferred embodiment thereof as defined above and in the claims, comprising
   a concave ion deflector, the concave ion deflector comprising
      a multitude of conducting electrodes forming an inward curved surface, and
      a pusher element for deflecting ions;
   an RF voltage supply for applying an RF voltage to the concave ion deflector, in particular for applying an RF voltage to at least a subset of the multitude of conducting electrodes of the concave ion deflector; and
   an output located outside the concave ion deflector and designed and configured to emanate a directed gas flow comprising ions;
b) emitting a directed gas flow comprising ions from the output and toward the inward curved surface of the concave ion deflector,
c) retaining and deflecting (at least part of the) ions which enter or approach the concave ion deflector while simultaneously allowing other particles coming from the output to pass through the inward curved surface.

With regard to further explanations of the method according to the invention and the devices used therein, reference is made to the above discussion of the apparatus, which also applies mutatis mutandis to the method.

### BRIEF DESCRIPTION OF THE DRAWINGS

The invention can be better understood by referring to the following figures. The figures are not intended to limit the scope of this invention, but merely to clarify and exemplify the invention. The elements in the figures are not necessarily to scale, emphasis instead being placed upon illustrating the principles of the invention (often schematically).

FIG. 1A depicts an exemplary arrangement for output (capillary), (tubular) shield and concave ion deflector in an apparatus according to a preferred embodiment of the invention.

FIG. 1B is a top view of the embodiment depicted in FIG. 1A.

FIG. 2 schematically depicts, in a cross-sectional view, an exemplary arrangement for output (capillary), (tubular) shield, concave ion deflector and pumping port in an apparatus according to a preferred embodiment of invention.

FIG. 3A illustrates, in a cross-sectional view, an exemplary arrangement for (tubular) shield and concave ion deflector in an apparatus according to a preferred embodiment of the invention in the context of a mass spectrometric set-up.

FIG. 3B schematically illustrates, in a cross-sectional view, another exemplary arrangement for output (capillary), (tubular) shield and concave ion deflector in an apparatus according to a preferred embodiment of the invention in the context of a mass spectrometric set-up.

FIG. 4A depicts, in angled view, an example for a multitude of U-shaped electrodes, wherein the U-shaped electrodes are aligned along a common axis such that said electrodes form an ion guiding path.

FIG. 4B is a rear view of FIG. 4A.

FIG. 4C is a side view of FIG. 4A.

FIG. 5A depicts, in angled view, another example for a multitude of U-shaped electrodes, wherein the U-shaped electrodes are aligned along a common axis such that said electrodes form an ion guiding path.

FIG. 5B is a rear view of FIG. 5A.

FIG. 5C is a side view of FIG. 5A.

FIG. 6A depicts a preferred embodiment of a concave ion deflector comprising an ion tunnel located upstream and an ion tunnel located downstream of the concave ion deflector.

FIG. 6B depicts a cutaway angled view of the embodiment depicted in FIG. 6A.

FIG. 7A depicts, in a cross-sectional top view, a preferred embodiment of a concave ion deflector comprising an ion tunnel located upstream and an ion funnel located downstream of the concave ion deflector.

FIG. 7B depicts an angled view of the cross-sectional view depicted in FIG. 7A.

FIG. 8A depicts a cutaway of a preferred embodiment of a concave ion deflector comprising an ion funnel through which directed gas flow comprising ions emanated from the output enters the concave ion deflector.

FIG. 8B depicts a side view of FIG. 8A.

FIG. 9A schematically depicts, in a cross-sectional view, a concave ion deflector with an inward curved surface comprising a protuberance.

FIG. 9B schematically depicts, in a cross-sectional view, the concave ion deflector of FIG. 9A and illustrates how the protuberance serves as a pseudo jet disruptor.

### DETAILED DESCRIPTION

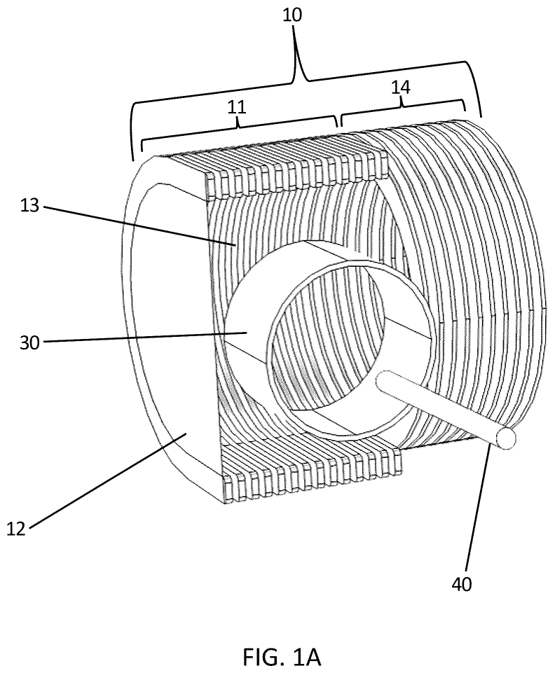

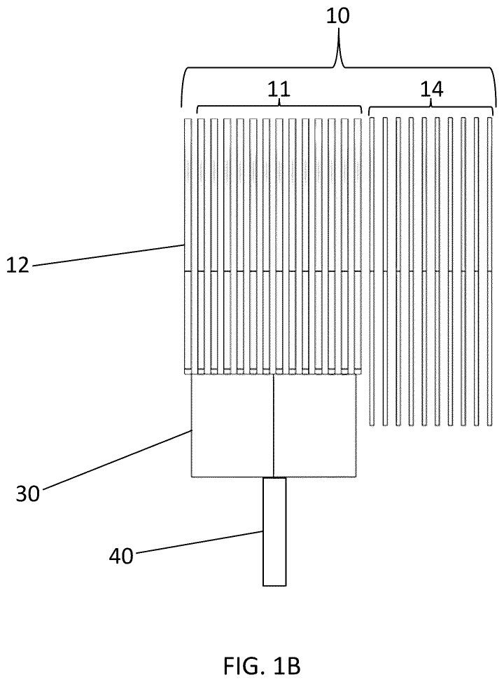

FIG. 1A shows an exemplary arrangement for output (capillary) 40, (tubular) shield 30 and concave ion deflector 10 in an apparatus according to a preferred embodiment of the invention. The concave ion deflector 10 comprises a multitude of concave (U-shaped) electrodes 11 aligned along a common axis and forming an inward curved surface 13, a repeller electrode 12 and an ion tunnel 14 located downstream of the concave ion deflector and formed by a plurality of ring electrodes which are aligned along the same axis as the multitude of concave electrodes 11. The concave ion deflector 10 comprises fourteen U-shaped electrodes and ten ring electrodes along its entire length in the example depicted, which can be supplied alternately with two phases of an RF voltage (0°-180°-0°-180°) in order to generate an electrical field that slows down the ions coming from the capillary 40 and prevents the ions from reaching the inward curved surface 13 of the concave ion deflector and therefore from getting in contact with the electrodes or from passing through the inward curved surface 13 of the concave ion deflector 10 via the gaps between the electrodes.

The concave ion deflector depicted in FIG. 1A comprises an opening through which a directed gas flow comprising ions emanated from the capillary 40 and moving toward the inward curved surface 13 of the concave ion deflector 10 can easily enter the concave ion deflector 10. The opening of the concave ion deflector 10 extends over the length of the alignment of the multitude of concave (U-shaped) electrodes 11 along a common axis. By the alignment of the multitude of concave (U-shaped) electrodes 11 along a common axis depicted in FIG. 1A (and the inward curved surface 13 formed thereby) an area or hollow space inside the concave ion deflector gets enclosed by 180°. The opening of the concave ion deflector 10, through which the directed gas flow comprising ions emanated from the capillary 40 and moving toward the inward curved surface 13 can enter the concave ion deflector, is nevertheless large enough for the ions to enter the concave ion deflector 10 substantially unaffected by any interfering fields.

As already mentioned, in FIG. 1A capillary 40 is designed and configured to emanate a directed gas flow comprising ions. The capillary 40 is arranged in such a way that the directed gas flow comprising ions emanated from the capillary 40 moves orthogonally toward the inward curved surface 13 of the concave ion deflector 10 or enters the concave ion deflector 10 orthogonal with respect to the common axis along which the U-shaped electrodes 11 are aligned. In the example displayed, ions may be formed at substantially atmospheric pressure by the electrospray process which is well known to a person skilled in the art. In this case, the capillary 40 emits a spray mist containing mainly gas, (charged or uncharged) droplets and ions of one or more analytes of interest at substantially atmospheric pressure. Atmospheric pressure in the sense of the present disclosure is intended to mean a pressure of at least about 103 Pascal, such as actual ambient pressure of the order of 105 Pascal. The spray emanated from the capillary 40 is then propelled toward the inward curved surface 13 of the concave ion deflector 10. The concave ion deflector 10 itself may be operated at a pressure of about 6 mbar. When approaching and entering the concave ion deflector 10, the ions contained in the spray mist interact with the RF field in the concave ion deflector 10 and are prevented by said field from continuing on their initial flight path predetermined by emission through the capillary 40. The other constituents of the spray mist, which are not held back by the electric fields prevailing in the concave ion deflector 10, continue to move toward the inward curved surface 13 of the concave ion deflector 10 and pass through it via the gaps between the U-shaped electrodes 11 or collide with the U-shaped electrodes 11 or other parts of the concave ion deflector 10.

The capillary 40 partly extends (outlet first) into a tubular shield 30 which is located directly in front of the opening of the concave ion deflector 10, through which the directed gas flow comprising ions emanated from the capillary 40 enters the concave ion deflector 10. Both the tubular shield 30 and the capillary 40 are located entirely outside the concave ion deflector 10. Due to the extension of the capillary 40, and in particular its outlet, into the tubular shield 30, the ions coming from the capillary 40 are additionally shielded on their way to the concave ion deflector 10 from any interfering fields that may occur in front of the concave ion deflector 10.

The concave ion deflector 10 comprises a repeller electrode 12 at one end thereof. A DC voltage may be applied to the repeller electrode 12, which establishes a DC gradient along the concave ion deflector 10, by which the ions entering the concave ion deflector 10 are guided along an ion guiding path in downstream direction along the concave ion deflector 10 to the other end of the concave ion deflector 10.

The electrospray process was briefly outlined in the context of FIG. 1A by way of example only and in a very schematic manner. Practitioners in the field will acknowledge that a wide variety of different embodiments of capillaries for electrospray ionization are at their disposal from which they may choose the most practicable. Implementations may include some that work with additional lateral flows of heated gas in order to increase the desolvation capacity of the capillary. Further, ion sources shall in any case not be limited to those that work with the electrospray principle. It is equally possible to deploy other means for ionizing a sample. One example would be an atmospheric pressure chemical ionization (APCI) source that ionizes gaseous neutral molecules that have been nebulized from a liquid by means of charge transfer reactions with certain reagent ions, as a skilled practitioner well knows.

FIG. 1B represents a top view of FIG. 1A. From this top view, the distances between the U-shaped electrodes 11 can be seen even better. As mentioned above, the main purpose of these distances is to allow those particles coming from the capillary 40, which are not retained and deflected along an ion guiding path in downstream direction by the electric fields prevailing in the concave ion deflector 10, to leave the concave ion deflector 10 in a quick and easy way.

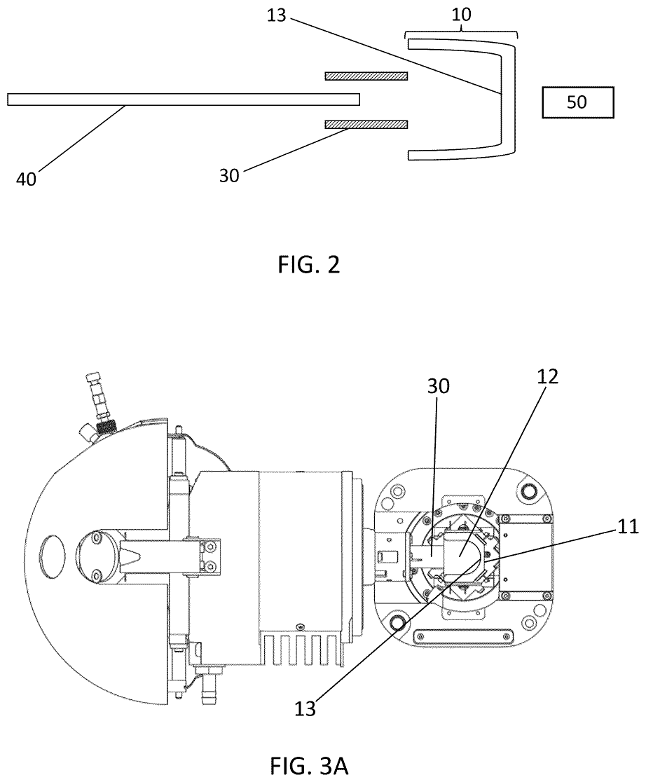

FIG. 2 shows a schematic cross-sectional view of an exemplary arrangement for capillary 40, tubular shield 30, concave ion deflector 10 and a pumping port 50 in an apparatus according to a preferred embodiment of invention. From the schematic cross-sectional view according to FIG. 2, it is in particular readily apparent that the capillary 40 is located outside the concave ion deflector 10. Also, according to the preferred embodiment of the invention shown here, the tubular shield 30 does not extend into the concave ion deflector 10, but ends in front of its opening, through which the ions and any other particles coming from the capillary 40 can enter the concave ion deflector 10. Moreover, the pumping port 50 located behind the concave ion deflector 10 allows those particles that pass through the inward curved surface 13 of the concave ion deflector 10 via the distances between the concave electrodes to be quickly removed out of the system.

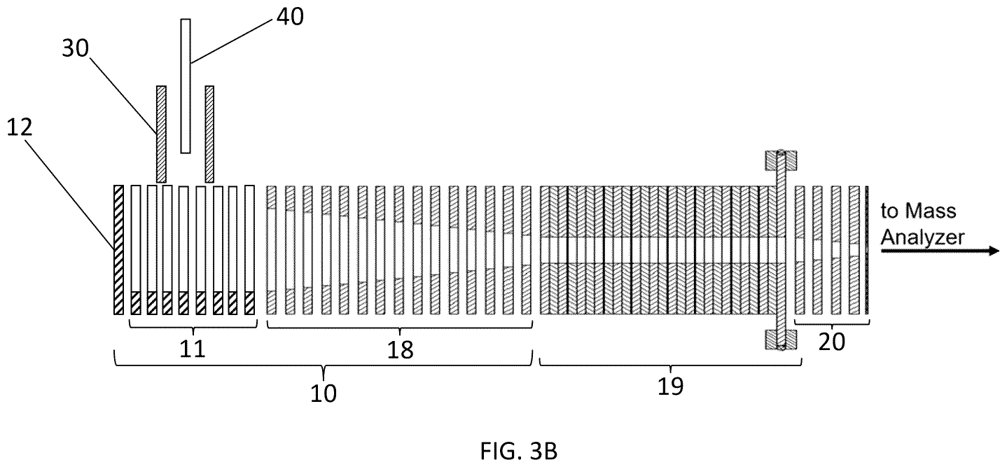

FIG. 3A illustrates, in a cross-sectional view, how a tubular shield 30, capillary 40 and concave ion deflector 10 of an apparatus according to a preferred embodiment of the invention may be embedded in a mass spectrometric set-up. In the arrangement according to FIG. 3A, the capillary 40 extends partly inside the tubular shield 30 but, however, is surrounded by the corresponding shield 30 and other components of the mass spectrometric set-up and is therefore not visible.

A way of how a tubular shield 30, capillary 40 and concave ion deflector 10 of an apparatus according to a preferred embodiment of the invention may be embedded in a mass spectrometric set-up is also schematically shown in FIG. 3B. In the mass spectrometric set-up according to FIG. 3B, the concave ion deflector 10 comprises an ion funnel 18 which is located downstream of the concave ion deflector 10 and which serves to further guide and confine the ions coming from the capillary 40. In the embodiment according to FIG. 3B, the ions are then transmitted to a drift tube or TIMS-tunnel 19 connected to the ion funnel 18 in order to separate the ions according to their ion-mobility and, after exiting the drift tube or TIMS-tunnel 19 via a further ion funnel 20, the ions are transferred to the mass analyzer of the mass spectrometric set-up.

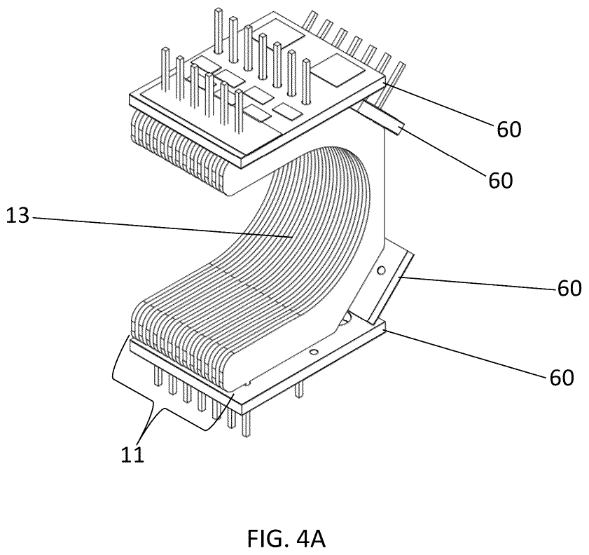

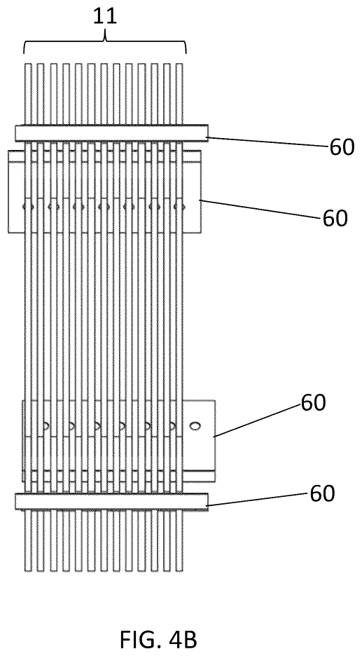

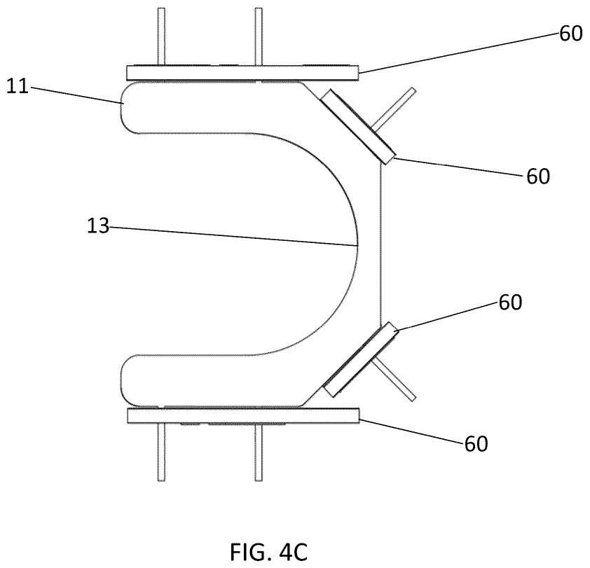

FIGS. 4A, 4B and 4C show, from different perspectives, an example for a multitude of U-shaped electrodes 11 aligned along a common axis (FIG. 4A: angled view, FIG. 4B: rear view, FIG. 4C: side view). According to FIGS. 4A, 4B and 4C, the U-shaped electrodes 11 are placed in a holder 60 through which the U-shaped electrodes 11 are held aligned.

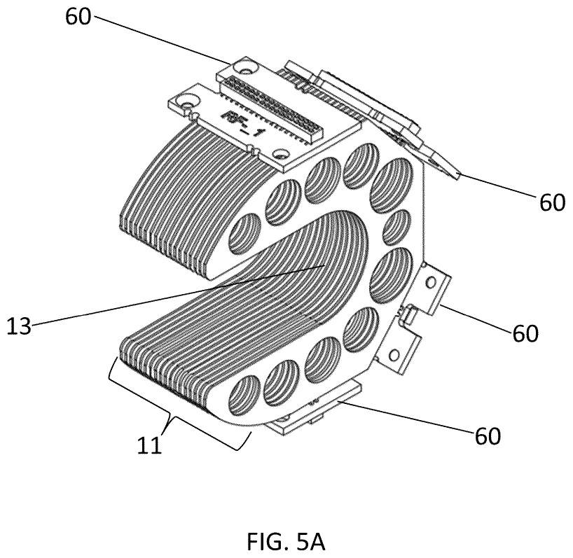

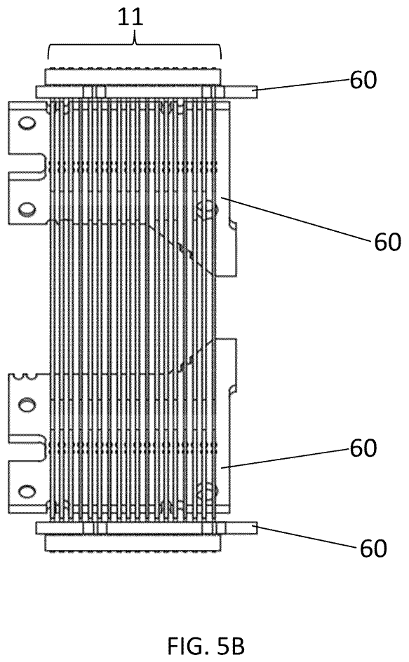

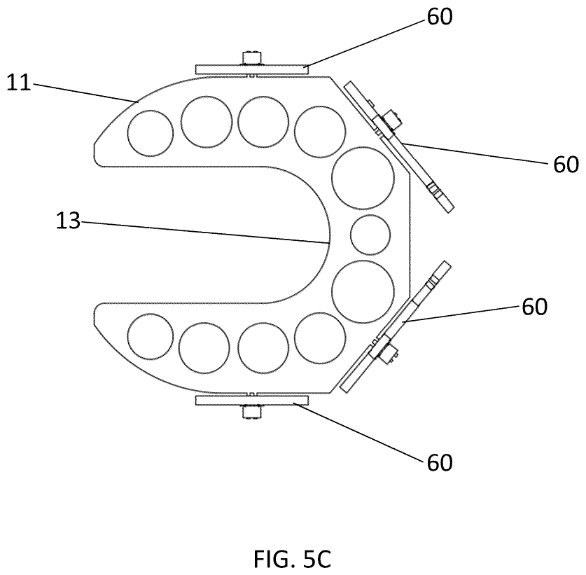

FIGS. 5A, 5B and 5C show, from different perspectives, another example for a multitude of U-shaped electrodes 11 aligned along a common axis (FIG. 5A: angled view, FIG. 5B: rear view, FIG. 5C: side view). By the circular holes in the electrodes illustrated in FIG. 5 the overlapping electrode area of adjacent electrodes is minimized to reduce the load presented to the RF generator, resulting in a capacitance reduction.

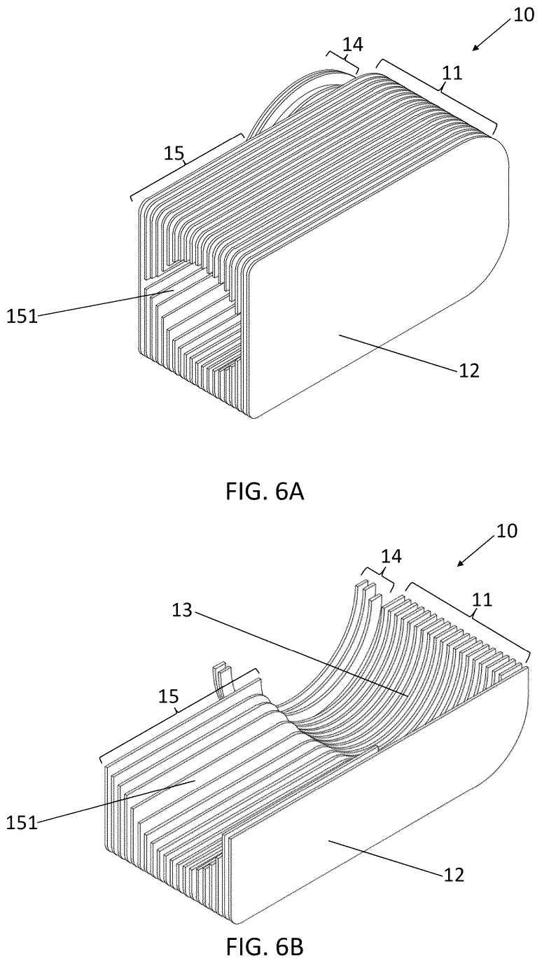

FIG. 6A shows an example of a concave ion deflector 10 comprising an upstream ion tunnel 15 through which a directed gas flow comprising ions emanated from the output 40 (not shown in FIG. 6A) and moving toward the inward curved surface 13 (visible in the cutaway angled view shown in FIG. 6B) can enter. The ion tunnel 15 is formed by an extension of the concave electrodes 11, which vary in such a way in their cutout that the ion tunnel 15 is created. The inner area of the ion tunnel 15 has a teardrop shape 151 in cross-sectional view (i.e., in view perpendicular to the direction of travel). Furthermore, in the preferred embodiment according to FIG. 6A, the repeller electrode 12 is extended over the whole length of the ion tunnel 15, such that a DC field can be applied perpendicular to the direction of travel of the ion tunnel 15. Ions that are entering the concave ion deflector 10 through the ion tunnel 15, are pushed by the DC field applied to the ion tunnel 15 to the narrow point in the teardrop shape (i.e., into the constriction of the ion tunnel 15) while continuing to move toward the inward curved surface 13 of the concave ion deflector 10. A pseudopotential barrier created by an RF voltage applied to the electrodes forming the ion tunnel 15 prevents the ions from striking the electrodes when being focused inside the constriction. The presence of the ion tunnel 15 through which ions contained in a directed gas flow coming from the output 40 can enter the concave ion deflector 10, combined with the RF field applied to the ion tunnel 15 preventing ions from being lost, enables lower DC gradients to be used as the residence time in the concave ion deflector is longer than without such an ion tunnel 15. According to FIGS. 6A and 6B, the concave ion deflector 10 also comprises an ion tunnel 14 located downstream of the concave ion deflector 10 in which the ions coming from the output (capillary) 40 are deflected and which serves to further guide and confine the ions.

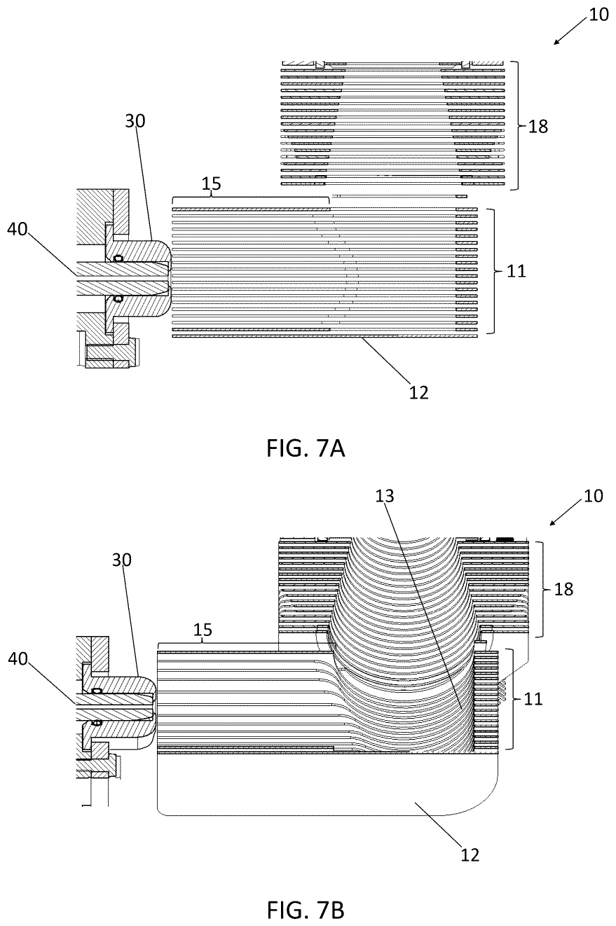

FIGS. 7A and 7B show a concave ion deflector 10 also comprising an upstream ion tunnel 15 through which a directed gas flow comprising ions emanated from the output 40 and moving toward the inward curved surface 13 can enter the concave ion deflector 10. According to FIGS. 7A and 7B, the concave ion deflector 10 also comprises a downstream ion funnel 18 into which the ions coming from the output (capillary) 40 are deflected and which serves to further guide and confine the ions.

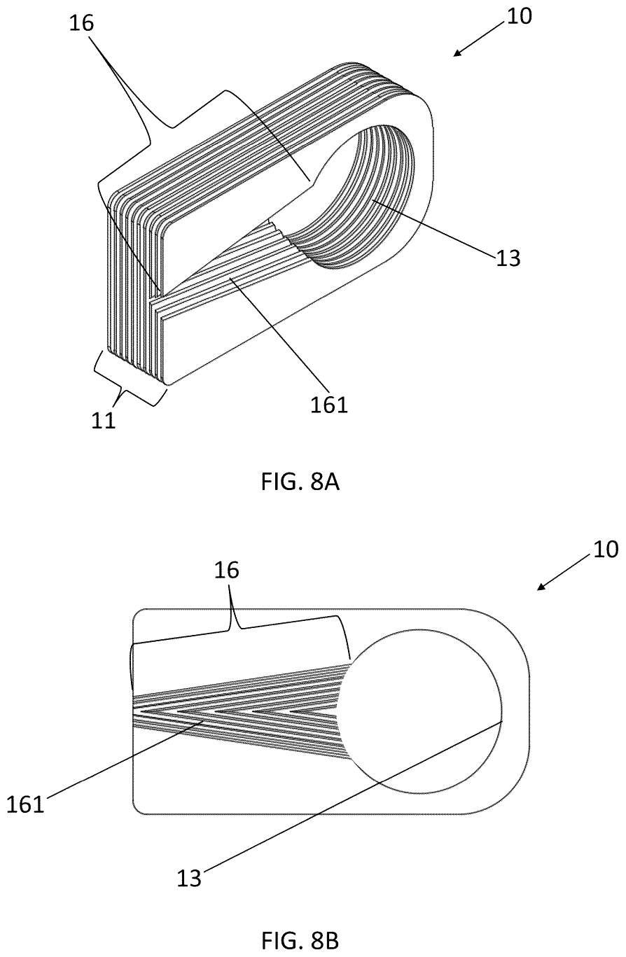

FIG. 8A, in cutaway angled view, shows an example of a concave ion deflector 10 comprising an ion funnel 16 through which a directed gas flow comprising ions emanated from the output 40 (not shown in FIG. 8A) and moving toward the inward curved surface 13 can enter the concave ion deflector 10. FIG. 8B shows a side view of FIG. 8A. In FIGS. 8A and 8B, the repeller electrode 12 of the concave ion deflector 10 is not visible due to the selected cutting direction through the concave ion deflector 10. The main difference between the concave ion deflector 10 displayed in FIGS. 8A and 8B and the concave ion deflector 10 displayed in FIGS. 6A and 6B is that in the concave ion deflector according to FIGS. 8A and 8B the extension of concave electrodes 11 forms an ion funnel 16 in which the inner diameter is diverging in downstream direction. The inner area of the ion funnel 16 also has in cross-sectional view (i.e., in view perpendicular to the direction of travel) a constriction 161 in which ions entering the concave ion deflector 10 can be focused on their way to the inward curved surface 13 of the concave ion deflector 10.

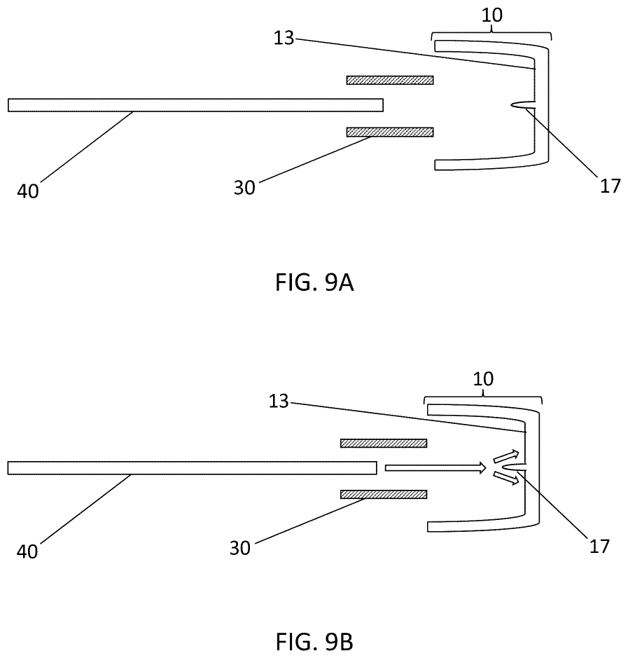

FIG. 9A schematically depicts, in a cross-sectional view, a concave ion deflector 10 with an inward curved surface 13 comprising a protuberance 17. FIG. 9B schematically illustrates, through the arrows visible therein, how the protuberance 17 depicted in FIG. 9A serves as a pseudo jet disruptor for breaking off a directed gas flow emanated from a capillary 40 to either side of the protuberance 17.

The invention has been shown and described above with reference to a number of different embodiments thereof. It will be understood, however, by a person skilled in the art that various aspects or details of the invention may be changed, or various aspects or details of different embodiments may be arbitrarily combined, if practicable, without departing from the scope of the invention. Generally, the foregoing description is for the purpose of illustration only, and not for the purpose of limiting the invention, which is defined solely by the appended claims, including any equivalent implementations, as the case may be.

1. An apparatus for an ion spectrometric system that facilitates the transmission of ions, said apparatus comprising:
a concave ion deflector, the concave ion deflector comprising:
a plurality of conducting electrodes forming an inward curved surface, and
a pusher element for deflecting ions;
an RF voltage supply for applying an RF voltage to at least a subset of the plurality of conducting electrodes of the concave ion deflector; and
an output configured to emanate a directed gas flow comprising ions; wherein
the output and the concave ion deflector are arranged relative to each other in such a way that the directed gas flow comprising ions is directed toward the inward curved surface of the concave ion deflector;
the output is located outside the concave ion deflector; and
the concave ion deflector is configured to retain and deflect ions from the output while simultaneously allowing other particles from the output to pass through the inward curved surface.

2. An apparatus according to claim 1, further comprising a DC voltage supply for applying a DC voltage to least a subset of the plurality of conducting electrodes and/or to the pusher element of the concave ion deflector.

3. An apparatus according to claim 1, wherein the pusher element comprises a repeller electrode.

4. An apparatus according to claim 1, wherein one or more electrodes of the plurality of conducting electrodes of the concave ion deflector are concave.

5. An apparatus according to claim 4, wherein one or more electrodes of the plurality of conducting electrodes of the concave ion deflector are C-shaped, U-shaped and/or horseshoe-shaped electrodes.

6. An apparatus according to claim 1, wherein the plurality of conducting electrodes of the concave ion deflector are aligned along a common axis such that said electrodes form an ion guiding path.

7. An apparatus according to claim 6, wherein adjacent aligned electrodes of the plurality of conducting electrodes of the concave ion deflector are separated from each other by separation distances and wherein one, several or all of said separation distances form flow paths through which particles coming from the output can exit the concave ion deflector.

8. An apparatus according to claim 6, wherein the output and the concave ion deflector are arranged relative to each other in such a way that the directed gas flow comprising ions emanated from the output moves toward and/or enters the concave ion deflector at an angle of 35 to 145° with respect to the common axis along which the plurality of conducting electrodes of the concave ion deflector are aligned.

9. An apparatus according to claim 8, wherein the output and the concave ion deflector are arranged relative to each other in such a way that the directed gas flow comprising ions emanated from the output moves toward and/or enters the concave ion deflector in a direction orthogonal to the common axis along which the plurality of conducting electrodes of the concave ion deflector are aligned.

10. An apparatus according to claim 1, wherein the output is a capillary or an orifice.

11. An apparatus according to claim 1, further comprising a shield, wherein the shield at least partially surrounds the output.

12. An apparatus according to claim 11, wherein the shield is located directly in front of the concave ion deflector and/or wherein the shield has the shape of a tube, and the output extends into the tube.

13. An apparatus according to claim 1, wherein each electrode of the plurality of conducting electrodes of the concave ion deflector is connected to an RF potential.

14. An apparatus according to claim 13, wherein the RF potential on any electrode of the plurality of conducting electrodes of the concave ion deflector connected to an RF potential is 180 degrees out of phase with the RF potential on an adjacent electrode.

15. An apparatus according to claim 1, further comprising at least one pumping port.

16. An apparatus according to claim 15, wherein the concave ion deflector is located between the output and the at least one pumping port.

17. An apparatus according to claim 1, wherein the concave ion deflector comprises at least one ion tunnel or ion funnel.

18. An apparatus according to claim 17, wherein the directed gas flow comprising ions emanated from the output enters the concave ion deflector via an ion tunnel or ion funnel, wherein the ion tunnel or ion funnel is configured to focus ions coming from the output while the ions are moving toward the inward curved surface of the concave ion deflector.

19. An apparatus according to claim 18, wherein the ion tunnel or ion funnel comprises a constriction along its direction of travel, into which the ions coming from the output are guided and focused on their way towards the inward curved surface.

20. An apparatus according to claim 18, wherein the directed gas flow comprising ions emanated from the output enters the concave ion deflector via an ion funnel with gradually increasing inner diameter along its direction of travel.

21. An apparatus for an ion spectrometric system that facilitates the transmission of ions, said apparatus comprising:
a concave ion deflector, the concave ion deflector comprising:
a plurality of conducting electrodes forming an inward curved surface, and
a pusher element for deflecting ions;
an RF voltage supply for applying an RF voltage to at least a subset of the plurality of conducting electrodes of the concave ion deflector; and
an output configured to emanate a directed gas flow comprising ions; wherein
the output is arranged such that a direction followed by the directed gas flow comprising ions intersects the inward curved surface of the concave ion deflector;
the output is located outside the concave ion deflector; and
the concave ion deflector is configured to retain and deflect ions coming from the output while simultaneously allowing other particles coming from the output to pass through the inward curved surface.

22. A method for facilitating the transmission of ions in an ion spectrometric system, the method comprising the steps of:
a) providing an apparatus comprising:
a concave ion deflector, the concave ion deflector comprising:
a plurality of conducting electrodes forming an inward curved surface, and
a pusher element for deflecting ions;
an RF voltage supply for applying an RF voltage to at least a subset of the plurality of conducting electrodes of the concave ion deflector; and
an output located outside the concave ion deflector and configured to emanate a directed gas flow comprising ions;
b) emitting a directed gas flow comprising ions from the output and toward the inward curved surface of the concave ion deflector, and
c) retaining and deflecting ions which enter or approach the concave ion deflector while simultaneously allowing other particles coming from the output to pass through the inward curved surface.
